(19) United States
(12) Patent Application Publication
(10) Pub. No.: US 2023/0179023 A1
(43) Pub. Date: Jun. 8, 2023

(54) Wireless Charging System for a Vehicle and Control Method

(71) Applicant: Motherson Innovations Company Limited, London (GB)

(72) Inventors: Marc ROSENMAYR, Farmington Hills, MI (US); Abdon Edward SAENZ DE VITERI, Farmington Hills, MI (US)

(21) Appl. No.: 17/925,630

(22) PCT Filed: May 21, 2021
(86) PCT No.: PCT/EP21/63678

§ 371 Date: Nov. 16, 2022

Related U.S. Application Data
(60) Provisional application No. 63/027,992, filed on May 21, 2020.

(51) Int. Cl. H02J 50/10; H02J 50/00; H02J 50/40

(52) U.S. Cl. CPC H02J 50/10; H02J 50/005; H02J 50/402; H02J 2207/30; H02J 2310/40

(57) ABSTRACT

The present disclosure refers to a wireless charging system for a vehicle, in particular in form of an in-vehicle wireless charging system, comprising: a body (102) or housing (200) defining a cavity (110, 202); at least two coils (100) arranged around the cavity (110, 202) and adapted to create a magnetic field (106) within the cavity (110, 202); and a control unit (16) connected to the at least two coils (100) and adapted to connect to a power supply. It also relates to a control method (700) providing a charging protocol for such a wireless charging system.

### CROSS REFERENCE TO RELATED APPLICATIONS

This application is an International Patent Application, which claims the benefit of priority to U.S. Provisional Application No. 63/027,992, filed on May 21, 2020, which is hereby incorporated herein by reference in its entirety for all purposes.

### TECHNICAL FIELD

The present disclosure relates to wireless charging of batteries, including batteries in mobile computing devices in a vehicle. In particular, it refers to a wireless charging system for a vehicle, like an in-vehicle wireless charging system, and a control method providing a charging protocol for such a wireless charging system.

### BACKGROUND ART

The statements in this section merely provide background information related to the present disclosure and may not constitute prior art.

Wireless charging of mobile computing devices allows for the charging of mobile devices such as phones, headphones, wearables or tablets. Wireless charging in vehicles is known to reduce issues with having charging wires which need to be plugged in at inconvenient locations or becoming an entanglement hazard during the operation of a vehicle. Current Qi technology systems require flat surface charging pads. The flat charging pads also require the mobile device to be aligned for charging in the correct position and in contact with or within a very small distance of the charging pad. Without a correct alignment and contact, wireless charging of the mobile device will not occur. Another limitation of current in-vehicle charging systems is they lack the ability to provide optimized charging for a device. They are limited to a specific charging protocol for all mobile devices, with minimum to no variation

It is the object of this invention to provide a wireless charging system for mobile devices in a vehicle that overcomes at least some of the stated problems above.

### SUMMARY OF INVENTION

This object is achieved with a wireless charging system for a vehicle, in particular in form of an in-vehicle wireless charging system, of claim 1. Preferred wireless charging systems of this disclosure are described in claims 2 to 11.

An in-vehicle wireless charging system for charging a mobile device is described herein. The in-vehicle wireless charging system may comprise a housing that defines a cavity, at least two coils arranged around the cavity, and a control unit connected to the at least two coils. The at least two coils and the control unit cooperate to form a transmitter. In one form, the at least two coils are independently connected to the control unit. In other variations the at least two coils may be connected to the control unit in either series, parallel, independently, or some combination thereof. The at least two coils may be nonplanar and create a static magnetic field within the cavity. The control unit regulates the current supplied to the at least two coils. Further, the control unit may comprise a connector to connect to a power supply which is either a vehicle power supply or a DC power source. The housing may be comprised of a nonmetallic material to ensure it does not interfere with the transmitter. The cavity may define a cup holder. In other variations, the cavity may define any form capable of retaining a mobile device. The transmitter may cooperate with a receiver within the mobile device.

A 3D magnetic field may be created for providing wireless charging in a vehicle environment. The exemplarily disclosed arrangements create a more user friendly charging environment in a vehicle by allowing for a larger air gap between a mobile device and in addition positional flexibility of the mobile device. The disclosed technology uses at least two nonplanar coil elements embedded in a vehicle component such as, but not limited to, a cup holder housing to create an inductive power field for wireless charging. Nonplanar is described herein as not being within the same plane. Each of the at least two nonplanar coil elements may be contained within a different plane. In one form this is an enhance Qi implementation that eliminates the requirement for strict alignment to charge mobile electronic devices in vehicle. In another variation this could use magnetic resonance.

The present disclosure also provides a control method providing a charging protocol for a wireless charging system of the present disclosure. Preferred methods are described in claims 13 to 21.

It should be noted that the features set out individually in the following description can be combined with each other in any technically advantageous manner and set out other forms of the present disclosure. The description further characterizes and specifies the present disclosure in particular in connection with the Figures.

### BRIEF DESCRIPTION OF DRAWINGS

In order that the disclosure may be well understood, there will now be described various forms thereof, given by way of example, reference being made to the accompanying, schematic drawings, in which:

FIG. 1 is an illustration showing a wireless charging system with two coils according to the present disclosure.

FIG. 2A is an isometric view of two coils with current flow according to a first embodiment of the present disclosure.

FIG. 2B is an isometric view of a multiple coil arrangement according to a first embodiment of the present disclosure.

FIG. 3 is an isometric view of a coil integrated housing configuration according to a fourth embodiment of the present disclosure.

FIG. 4 is isometric view of a further coil integrated housing configuration according to a fifth embodiment of the present disclosure.

FIG. 5A is an isometric view of the coil integrated housing configuration of FIG. 4 with alternate mobile device placement according to the present disclosure.

FIG. 5B is an isometric view of the coil integrated housing configuration of FIG. 4. with alternate mobile device placement according to the present disclosure.

FIG. 6 is a top view of the coil integrated housing configuration of FIG. 4. illustrating zone charging areas according to the present disclosure.

FIG. 7 is an optimization method of detecting and charging a mobile device according to the present disclosure.

### DESCRIPTION OF EMBODIMENTS

The following description is merely exemplary in nature and is not intended to limit the present disclosure, application, or uses. It should be understood that throughout the drawings, corresponding reference numerals indicate like or corresponding parts and features. Individual features described with reference to one or more of the different embodiments of the present disclosure can be used in another embodiment as well.

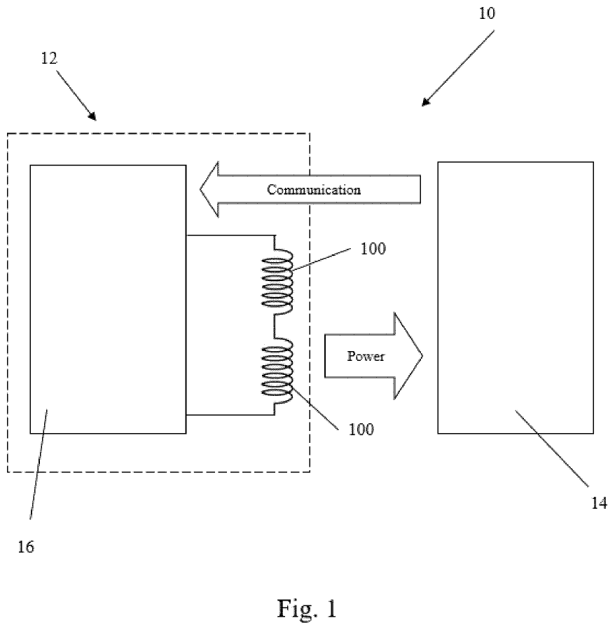

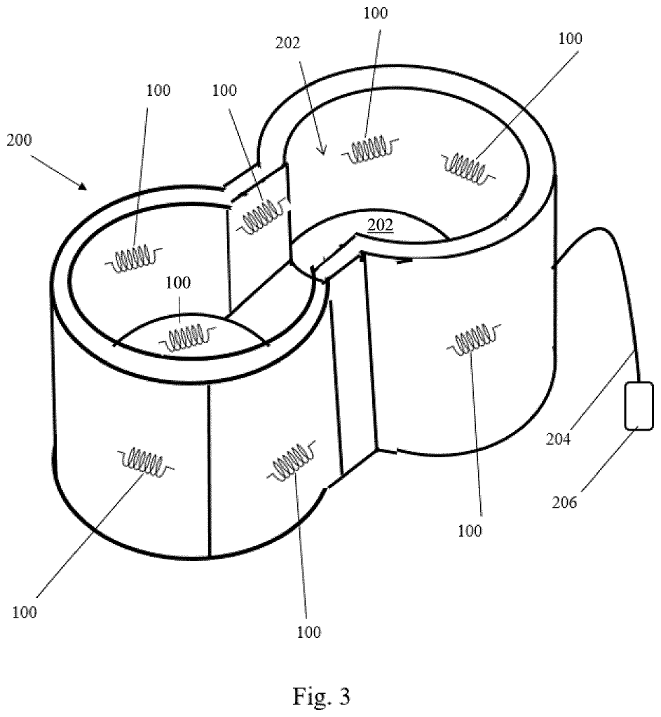

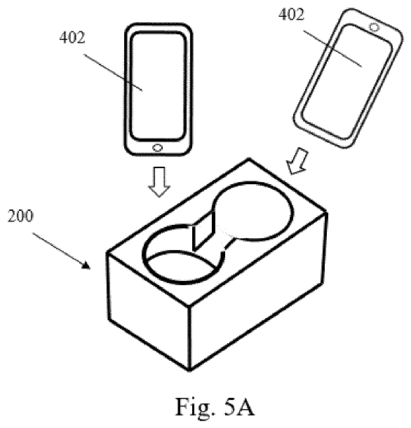

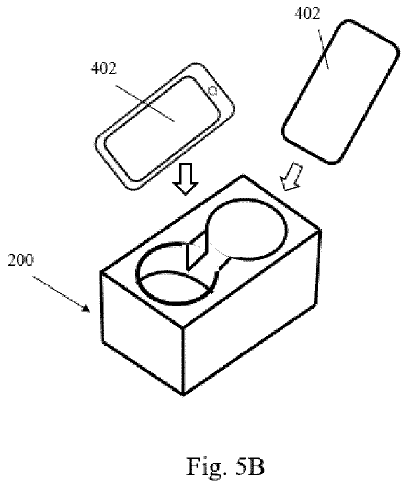

FIG. 1 illustrates a wireless charging system 10 for integration in a vehicle, not shown. The wireless charging system 10 has a transmitter 12 and a receiver 14. The receiver 14 is a known component integrated in a mobile device 402, as seen in FIGS. 5A and 5B, such as a cell phone, tablet, headphones, or any other compatible wireless device. The transmitter 12 is integrated into a component housing, see housing 200 in FIG. 3 to FIG. 5B, for use in a vehicle. The transmitter 12 has a control unit 16 and at least two coils 100. In this embodiment, the coils 100 are connected to the control unit 16 in series. In other variations, the coils 100 may be independently connected or connected in parallel to the control unit 16. The control unit 16 receives communication signals from the receiver 14 and controls the current to the at least two coils 100 for providing wireless charging power to the receiver 14. The functionality of these components for wireless charging will be discussed in further detail in a later paragraph.

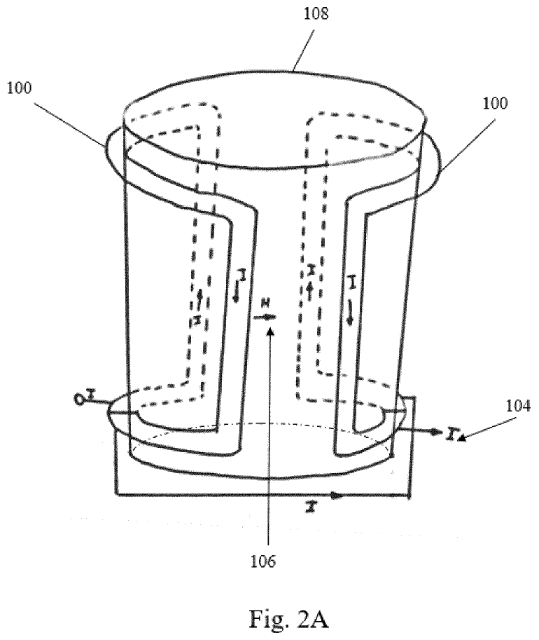

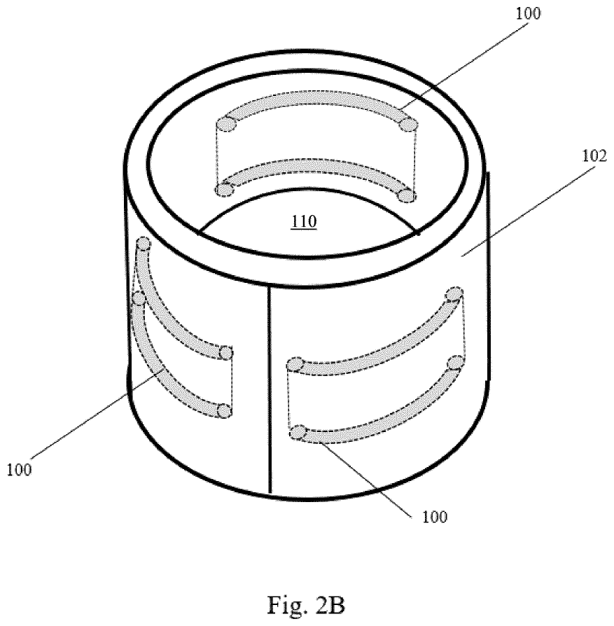

FIG. 2A illustrates an example of a coil configuration with a current (I) flow 104. The coils 100 produce a region of a magnetic (H) field 106. In this embodiment, the magnetic field 106 is static and nearly uniform. The at least two coils 100 would serve as the transmitter 12, as seen in FIG. 1, of the wireless charging system 10. Any mobile device 402, as seen in FIGS. 5A and 5B, contains a receiver coil to enable the mobile device to act as a receiver 14. When the mobile device 402 is placed within the magnetic field 106 produced by the two coils 100, the mobile device 402 receives wireless power and converts it into electrical energy to power, which is stored within the mobile device 402.

The amount of coils can vary, but there are at least two. The at least two coils 100 are embedded in a body 108 to give form and structure to the coil 100 arrangement. In this form, the body 108 takes on the form of a cylinder typically associated with that of a cup holder. The body 108 may be any form or shape that is capable to house the coils 100.

The coils 100 are not limited by the graphical representation in FIG. 2A or FIG. 2B, to be discussed below in detail, and may take any coil structure known in the art for the creation of a magnetic field 106. Two nonplanar coils 100 are illustrated in FIG. 2A to create the magnetic charging field 106 but additional (not shown) coils 100 may be used depending on the design and area to be covered by the magnetic charging field 106. Nonplanar is described herein as not being within the same plane. Each of the at least two nonplanar coils 100 are contained within a different plane.

The coils 100 may be within 10 inches of one another, preferably no more than 3 inches. The distance depends on the amount as well as dimensioning of the coils and the body 108.

FIG. 2B is an isometric view of the body 108 with a cavity 110. In this embodiment, three embedded coils 100 are arranged around the perimeter of the cavity 110. This arrangement of the coils 100 will create a magnetic field 106 in the cavity 110 when current flows through the coils 100. A mobile device 402 placed in the cavity 110 would receive charging from the magnetic field 106 created by the coils 100. In other variations, the amount and arrangement of the coils 100 may be adjusted to conform to design constraints.

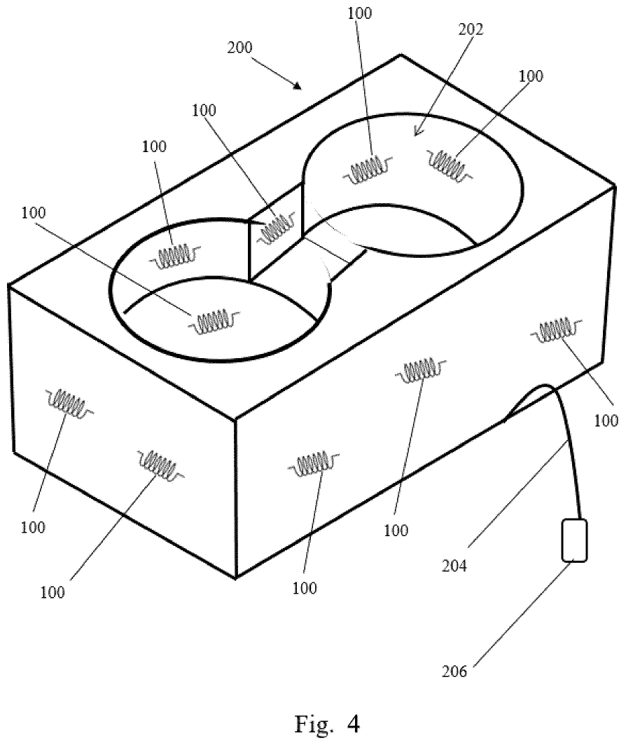

FIG. 3 and FIG. 4 illustrate two design variants having coils 100 placed around a housing 200, with different numbers of coils 100, and different structures of the housing 200.

FIG. 3 shows the housing 200 with a cavity 202. The housing 200 is designed having a cavity 202 and embedded nonplanar coil elements 100. In this form, the housing 200 takes on the form of a dual cylinder typically associated with that of a dual cup holder. The housing 202 may be in any form or shape that is capable to house the coils 100. Potential placements of coils 100 are represented in FIG. 3. These potential placements are representative of a coil arrangement which would create a magnetic field 106, shown in FIG. 2A, in the cavity 202. This is one representation of the coils 100 around the housing 200. The location and amount of coils 100 may be adjusted based on the desired size and control of the magnetic field 106 created. The depicted arrangement of coils 100 is not intended to limit the amount or arrangement for any coils 100 around housing 200.

In this form, cavity 202 is sized and configured to allow for placement of a cup in the housing 200 creating a dual cup holder functionality. This configuration of housing 200 in a vehicle may also provide a storage location for other small items in a vehicle such as keys, coins, or a mobile device 402. The illustration of housing 200 as a dual cup holder is not intended to limit the use of this disclosure to a dual cup holder. The cavity 202 may be sized and designed to accommodate any shape desired including a single cup holder option, box, or other container configuration within the scope of this disclosure. The housing 200 in FIG. 3 is shown in a configuration example which would allow the housing 200 to be placed or installed in a vehicle console or door trim to provide a dual function of cup holder or storage container, and mobile device wireless charging unit as a separated molded feature.

The housing 200 may be constructed of a moldable plastic, polymer material, or nonmetallic material which is capable of having at least two nonplanar coils 100 embedded in the housing around the cavity 202. The coils 100 may be molded into the housing 200 wherein at least two coils 100 are in a nonplanar arrangement.

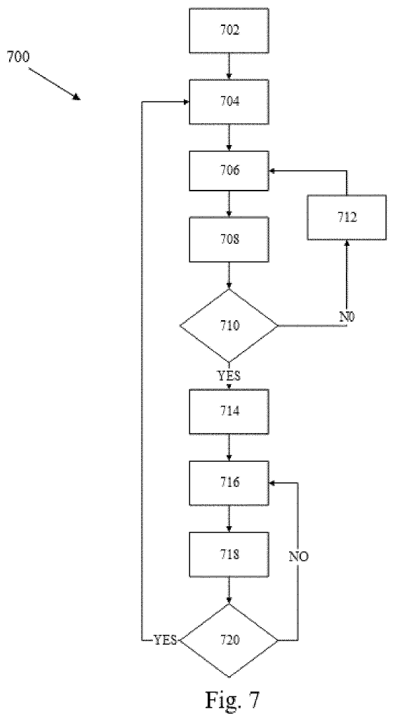

A wire 204 and a connector 206 provide power to the control unit 16 and the coils 100 when a charging protocol or control method 700, as depicted in FIG. 7, is initiated. The wire 204 may also be directly connected to a vehicle power supply, not shown. The wire 204 may function with a connector 206. The connector 206 could provide a connection for a USB, 12 volt connection, or any other electrical connection to provide power for the coils 100. In this form, the connector 206 provides a connector for the housing 200 to be designed as an aftermarket product and connected to the vehicle power outlet to wirelessly charge the mobile device 402. The connector 206 may also be directly embedded in the housing 200 for a direct connection to a charging system.

FIG. 4 illustrates a variation of the housing 200. In this form, the housing 200 has the coils 100 embedded into a larger console unit for use in a vehicle. This housing 200 may be part of a larger console system in a vehicle and contains additional functionality. At least two coils 100 are arranged around the cavity 202 in a nonplanar arrangement creating a magnetic field 106, as seen in FIG. 2, in the cavity 202. As in FIG. 3, this is a non-limiting example for the amount and arrangement of coils. The magnetic field 106 will provide wireless charging to a mobile device 402 placed in the cavity 202 when the coils 100 are activated.

FIGS. 5A and 5B illustrate the positional flexibility of the charging of a mobile device 402 with coil elements 100. Current charging solutions are limiting to specific placement and orientation of the mobile device 402. In this disclosure, the mobile device 402 maybe be placed in any configuration and position in the housing 200 to receive charging. The example orientations of mobile device 402 are not intended to limit the charging of a mobile device to any orientation or positional placement in the housing 200. The flexibility of the placement and orientation of the mobile device 402 in the housing 200 to be charged by coils 100 with the control method 700, as seen in FIG. 7, is an advantage of this disclosure.

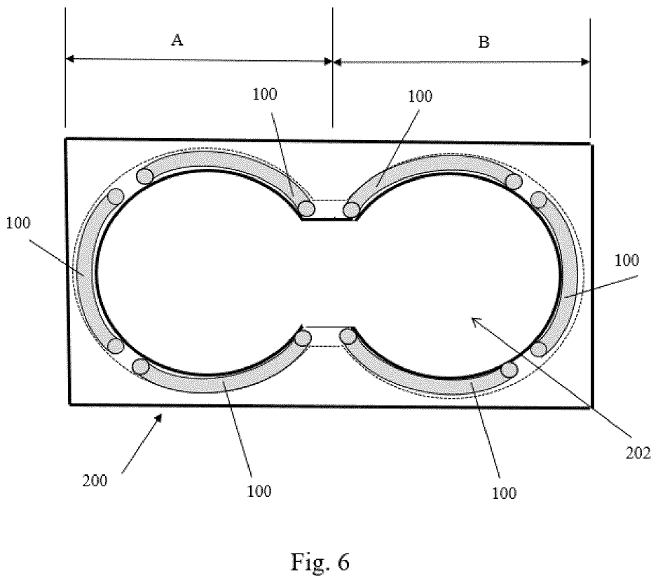

FIG. 6 illustrates a top view of the housing 200. The housing 200 is shown with embedded nonplanar coils 100 arranged around a cavity 202. The coils 100 may be arranged such that wireless charging zones with magnetic field 106 are created for charging a mobile device 402. In FIG. 6, the housing 200 is divided into two charging zones a zone A and a zone B. Any number of zones may be created based on the desired charging strategy and the arrangement of coils 100 in the housing 200. Zone charging is another advantage of the wireless charging system which may be used with the coils 100. At least one charging zone is created with coils 100 for charging.

The control unit 16 communicates and activates zones according to the method 700, as seen in FIG. 7. In FIG. 6, the two zones A and B represent different zones where the charging may occur after the mobile device 402 is detected. Once the mobile device 402 is detected, the method 700 may determine a zone where the mobile device 402 will be charged based on the location of the mobile device 402 in the cavity 202.

FIG. 7 illustrates the control method 700 in form of a charging optimization method.

In a step 702 a communication link with the mobile device 402 is established. The communication link is adapted to the communication which occurs between the receiver 14 in the mobile device 402 and the control unit 16. Once a communication link has been established between the control unit 16 and the receiver 14, the control unit 16 applies an initial current split to the at least two coils 100 in a step 704.

This initial current split in step 704 allows for each of the at least two coils 100 to be activated at an initial current level setting, which may be set at the same level for all the at least two coils 100. The initial current level setting may also be different for the at least two coils 100. In another form with at least three coils 100, the initial current level setting may be the same current level for at least two coils 100 and a different current setting for at least one coil 100. In other variations, there may be any combination of the same current levels and differing current levels for the at least two coils 100. This initial current split may be determined by the control unit 16 based on the detected location of the receiver 14 and direction of the communication link from the receiver 14 in relation to the at least two coils 100.

When utilizing the zones described in FIG. 6, the at least two coils 100 in zone A, and zone B may be powered and operated independently. For example, if a receiver 14 is detected in zone A as described in regard to FIG. 6, the at least two coils 100 located in zone A may receive an initial current where the at least two coils 100 in zone B may receive no current.

After the selected coil current configuration and initial current setting has been initiated by the controller 16, the receiver 14 measures the received power from the magnetic field 106 generated by activating at least two coils 100. The receiver 14 communicates the received power level to the control unit 16 in a step 706.

The control unit 16 may be any electronic control unit (ECU) that is capable of storing and processing data in the vehicle. The control unit 16 stores the communicated power level from the receiver 14 of the mobile device 402 with the corresponding current split between each of the at least two coils 100 and the direction of the magnetic field 106 in a step 708. This creates an accessible and comparable stored record for a specific current level in the at least two coils 100 correlated to the received power in the receiver 14. The control unit 16 is able to adjust the current provided to the at least two coils 100 changing the produced magnetic field 106 and potentially providing a different received power in the receiver 14.

In a step 710, the control unit 16 checks to see that all directions of the magnetic field have a recorded value from the receiver 14. The control unit 16 can provide current adjustment to the at least two coils 100 which changes the direction of the magnetic field 106 in increments up to 90 degrees. In one example, if the control unit 16 is set to use an increment of 90 degrees, there will be 4 records stored in the control unit 16 as the magnetic field 106 will be created with 4 inputted current levels to the at least two coils 100. In other variations, the number of variations is calculated by dividing 360 degrees by degree increment desired. Once the control unit 16 has tested the number of variations desired, the records are complete for comparison. If all increments of the magnetic field variation do not have a corresponding power level from the mobile device 402 stored in the control unit 16 then the optimization of the magnetic field is not complete.

A step 712 adjusts the current split to change the direction of magnetic field 106 which alters the direction of the magnetic field and potentially the power lever perceived by the receiver 14. This adjustment may be set as a standard pattern or may be an adaptive learning algorithm set up in the control unit 16 to manipulate the magnetic field 106 in the cavity 202.

As another non-limiting example of a current adjustment, the current split to the coils 100 is changed to rotate the magnetic field 106 by fifteen degrees in the cavity 202 after each feedback received from the receiver 14. In this case, the control unit 16 continues to adjust the direction of the magnetic field through increments of 15 degrees checking at step 710 until reaching a complete rotation of the magnetic field 106. The adjustment sequence for the magnetic field may be adjusted based on the placement and number of coils 100, the size of the cavity 202, and the receiver 14.

Once all the magnetic field directions set by the control unit 16 have been measured and recorded with the power level from the receiver 14, a step 714 compares the recorded power levels from the receiver 14 stored in the control unit 16.

The highest value of received power to the receiver 14 and the associated current split setting is selected in a step 716. The control unit 16 adjusts the current split settings of the at least two coils 100 to the selected level. This will produce the highest received power at the receiver 14 optimizing the power charging to charge the device 402.

In a step 718, the control unit 16 continues to monitor the received power communicated from the receiver 14 and compares the latest received communicated power level from step 716 with the highest stored power level from step 714. This step ensures the power charging level previously determined is at the desired level.

A step 720 compares the newly monitored power level with the stored power level. If the newly recorded power level from step 716 is lower than the highest stored power level from step 714, the system will revert back to step 716. If the recorded power level from step 716 is less than the highest stored power level from step 714, the system will revert back to step 704 to optimize the power level with a potential new current split. This monitoring and re-optimization of the current split allows for any potential movement of the mobile device 402 in the cavity 202 during operation of the vehicle and still maintains the highest possible wireless charging. In step 718, if the power level determined in step 714 is the same or higher when compared to the received power level in Step 716, the control unit 16 maintains the current split setting to the at least two coils 100.

This disclosure illustrates the coil implemented into a cup holder housing of a vehicle. The described method and coil implementation is not limited to just a cup holder housing. The method 710 and the coils can be applied to any housing structure that may be in a vehicle and hold a mobile device 402.

The foregoing description of various preferred embodiments have been presented for purposes of illustration and description. It is not intended to be exhaustive or to limit the disclosure to the precise forms disclosed, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. The features of the invention disclosed in the foregoing description, in the drawings and in the claims can be essential both individually and in any combination for the implementation of the invention in its various embodiments.

### REFERENCE SIGNS

10 Wireless Charging system
12 Transmitter
14 Receiver
16 Control Unit
100 Coil
104 Current (I)
106 Magnetic Field (H)
108 Body
110 Cavity
200 Housing
202 Cavity
204 Wire
206 Connector
402 Mobile Device
700 Control Method
702 Establish communication link with device
704 Control unit applies initial current split to the coil system
706 Receiver device measures received power and communicates the power level to the control device
708 Control unit stores the communicated power level and the corresponding current split
710 Have all directions of the magnetic field been measured?
712 Adjust current split to change the direction of the magnetic field
714 Apply the current split to the coils system which created the highest level of received power
716 Receiver device continues to measures received power and communicates the power level to the control device
718 Control unit compares the communicated power level with the highest stored power level
A Zone
B Zone
I Current
H Magnetic Field

1. A wireless charging system for a vehicle comprising:
a housing defining a cavity;
at least two coils arranged around the cavity and adapted to create at least one inductive power field for wireless charging, comprising a magnetic field within the cavity;
a control unit connected to the at least two coils and adapted to connect to a power supply;
wherein the power supply is connected to the control unit and the at least two coils via a connector embedded in the housing; and
wherein the connector and the housing are configured to connect the at least two coils and the control unit to the power supply upon installation of the housing onto the vehicle.

2. The wireless charging system of claim 1, wherein the power supply is one of a USB or a 12 Volt power source.

3. The wireless charging system of claim 1, wherein the power supply is at least one of a vehicle power supply or a DC power source.

4. The wireless charging system of claim 1, wherein the at least two coils and the control unit cooperate to form at least one transmitter, and each transmitter cooperates with a receiver of a mobile device to provide power to the mobile device.

5. The wireless charging system of claim 1, wherein the at least two coils are arranged to provide at least one wireless charging zone via the magnetic field; and
wherein the housing is divided into at least two charging zones.

6. The wireless charging system of claim 1, wherein the at least two coils are nonplanar;
wherein the magnetic field is static; and 3-dimensional; and
wherein the orientation of each magnetic field is controlled via the control unit.

7. The wireless charging system of claim 1, wherein the control unit regulates a current supply to the at least two coils; and
wherein the at least two coils are independently controlled by the control unit.

8. The wireless charging system of claim 1, wherein one coil of the at least two coils is arranged at the bottom of the cavity.

9. The wireless charging system of claim 1, wherein the cavity defines at least one cup holder.

10. The wireless charging system of claim 1, wherein the housing is constructed of a moldable nonmetallic material;
wherein, the at least two coils are embedded in the housing; and
wherein the at least two coils are in a nonplanar arrangement.

11. The wireless charging system of claim 1, wherein the housing is adapted to be installed in a vehicle interior, and the housing is adapted to provide storage.

12. (canceled)

13. A control method for a wireless charging system comprising the steps of:
providing a charging system having a control unit, a housing defining a charging zone, at least two coils arranged around the charging zone and adapted to create at least one inductive power field for wireless charging within the charging zone wherein the power supply is connected to the control unit and the at least two coils via a connector embedded in the housing; and
activating the charging zone via the connector, the power supply, the at least two coils and the control unit upon detecting a mobile device in the charging zone.

14. The method of claim 13, comprising the steps of:
establishing a communication link between the control unit and a receiver in the mobile device;
applying current to the at least two coils via the control unit;
measuring the power level received by the receiver and communicating a measured power level to the control device;
storing the measured power level in the control unit; and
comparing the measured power level with a highest stored power level in the control unit.

15. The method of claim 14, wherein once a communication link has been established between the control unit and the receiver, the control unit applies an initial current split to the at least two coils, such that each coil in the at least two coils is configured to be activated at an initial current level setting.

16. The method of claim 15, wherein the initial current split is determined by the control unit based on a detected location of the receiver.

17. The method of claim 15, wherein the control unit stores the measured power level from the receiver, the corresponding current split between each of the at least two coils, and the direction of the magnetic field; and
wherein the control unit adjusts the current provided to the at least two coils to adjust the magnetic field and to provide a different power to the receiver; and
wherein the control unit checks all directions of the magnetic field for a measured power level from the receiver.

18. The method of claim 15, further comprising the step of:
adjusting the current split to change the direction of magnetic field, preferably based on a standard pattern or an adaptive learning algorithm set up in the control unit to manipulate the magnetic field in the charging zone.

19. The method of of claim 15, further comprising the steps of:
comparing the recorded power levels from the receiver stored in the control unit; and
selecting the highest power level of the received power levels to the receiver and the associated current split setting, and adjusting the current split settings of the at least two coils to the selected power level by the control unit.

20. The method of claim 19, further comprising the steps of:
continuing to monitor the measured power level from the receiver via the control unit; and
comparing the latest received measured power level with the highest stored power level to ensure that the power charging level is at the highest power level.

21. The method of claim 20, further comprising the steps of:
reapplying current to the at least two coils via the control unit if the latest received measured power level is less than the highest stored power level to optimize the power level with a potential new current split; and
maintaining the current split settings for the at least two coils if the highest stored power level is the same as or higher than the received power level.
